(19) United States
(12) Patent Application Publication
(10) Pub. No.: US 2020/0179201 A1
(43) Pub. Date: Jun. 11, 2020

(54) APPARATUS AND METHOD FOR A BATHER SUPPORT SYSTEM

(71) Applicant: Andrew Dancy, Cicero, IL (US)

(72) Inventor: Andrew Dancy, Cicero, IL (US)

(21) Appl. No.: 16/210,634

(22) Filed: Dec. 5, 2018

(51) Int. Cl. A61G 7/10; A47K 3/00; A47K 3/022

(52) U.S. Cl. CPC A61G 7/1003; A47K 3/022; A61G 7/1059; A47K 3/006

(57) ABSTRACT

A bather support system is presented. The system has a walk-in tub which has a seat, integral to the walk-in tub. The seat has a telescopic post, the telescopic post being controlled by a controller and a motor. The motor is coupled to the seat and the control has settings being changeable by a user and the control being coupled to the seat, the controller adjusting the seat accordingly.

### FIELD OF THE INVENTION

The present invention relates generally to bather support seating, and particularly to a bather support seating that is adjustable.

### BACKGROUND

Entering and exiting from a typical bathtub may be a difficult process for some elderly or disabled persons. Particularly, rising from a seated position down within a bathtub requires considerable strength, balance and range of motion which may be limited in some by a disability or effects of aging.

However, one solution is to provide a seating surface onto which the bather may sit, whereby the seating surface may be lowered and elevated by powered means, leaving the user with the lesser tasks of managing to transfer on to and from the seating surface to take a full immersion bath. This function has been presented in prior art devices which are popularly referred to as bath lifts.

While various bath lift devices have been available in the prior art, these bath lifts suffer from several shortcomings relating to performance, weight and cost. Most of the prior art devices are cumbersome and heavy to lift due to large frame structures making it difficult for other bathtub users to remove the device from the bathtub when not needed.

Some prior art devices have water powered type linear actuators employing rubber type sliding seals that tend to wear out, leak, or stick when allowed to run dry for a period. Further, many existing art bath lift seats give the user an unstable feeling in the elevated seat position due to design limitations which permit considerable rocking motions of the seat. Additionally, the complex nature of many of the existing bath lifts result in a prohibitively high cost for many individuals who could otherwise benefit from a bath lift device.

A major complaint of existing art bath lift seats is that the horizontal portion of the seat surface is only able to lower to within three to four inches of the bath tub floor surface due to the lifting mechanisms, seat guides, and frame structure being located below the seat surface. This results in an incomplete immersion bathing experience for those persons who could most benefit from complete submersion bathing, and results in a considerable amount of water wastage during the life of the bath lift device.

### BRIEF DESCRIPTION OF THE DRAWINGS

FIG. 1 is a prior art view of walk-in shower/tub.

FIG. 2 is an exemplary view of bather support seat.

FIG. 3 is an exemplary controller.

FIG. 4 is an exemplary view of bather support seat after actuation of a controller.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

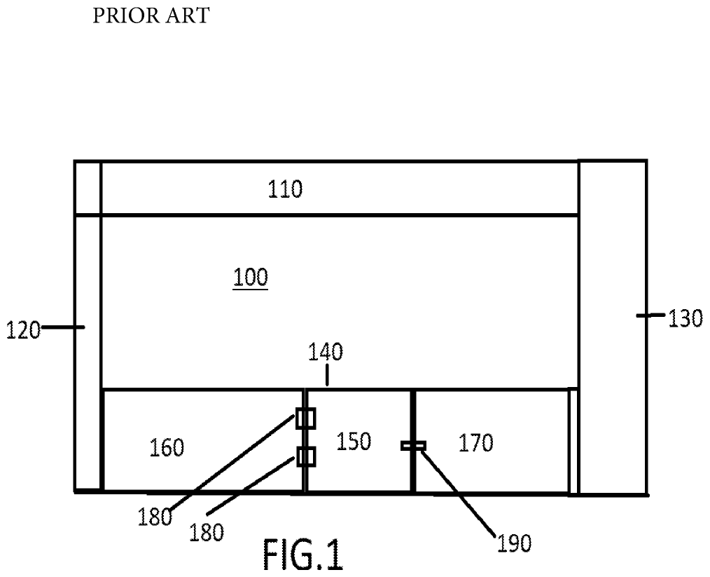

Referring now to FIG. 1, a prior art view of a walk-in shower/tub is shown. The walk-in shower/tub 100 has four sides. A back side 110 of the tub 100 is a vertical wall that may allow access to bathing materials. A left side 120 of the tub 100, this wall is opposite of a water emitting side of the tub 100.

A right side 130 of the tub 100. The right side 130 of the tub 100 has the controls for turning the water on and off. The right side 130 of the tub 100 also has fixtures for allowing water to fill the tub 100 or to be expelled from the shower fixture, not shown.

The tub 100 has an open side 140. The open side 140 of the tub 100 is normally a single piece or completely open, in the case of a shower only facility. The open side 140, as shown, has a door 150 situated between two solid sides 160, 170.

The door 150 is hinged attached to first of the solid sides 160 by two hinges 180. The door 150 has a coupling 190 to the second of the solid sides 170. The coupling is used secure the door 150 to the second of the solid sides 170. The door 150 is used to enter and leave the walk-in tub 100.

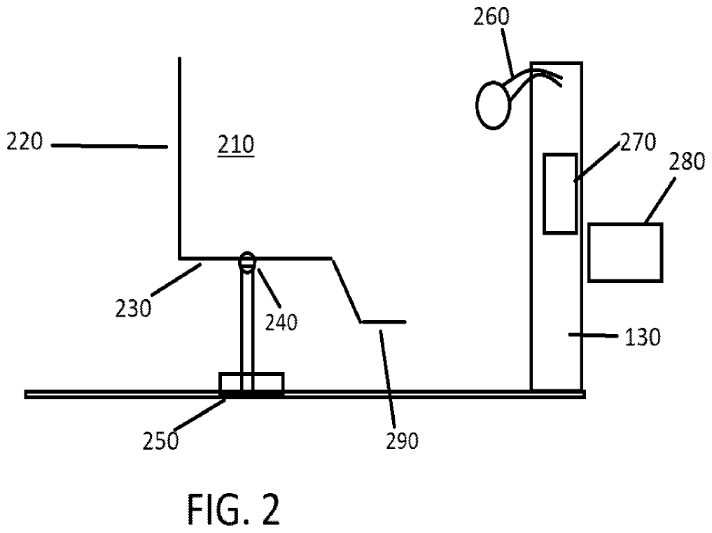

Moving now to FIG. 2, an exemplary view of the bather seat support is presented. The tub 100 now has a seat 210. The seat 210 has a back rest 220 and a seating area 230. The seat 210 may be made from any material that can withstand water and is comfortable and strong enough for a person to sit while taking a shower or bath. The seat 210 may be made of polyvinyl chloride (PVC), a mesh, teak, etc. The back rest 220 may have a massage or vibration mechanism.

The seat 210 has an adjustable pole 240 coupled to the seating area 230 at its base 240. The adjustable pole 230 is coupled securely to the floor of the tub 100. The seating area 230 may further have a vibration or massage mechanism. The adjustable pole 250 may be coupled via a permanent connector, or it may be temporary in that it is portable. Further coupled to the seating area 230 is one or more foot-rests 280. The foot rests 290 being for user having a comfortable place to put their feet and may also include a massage or vibration mechanism.

The right side 130 of the tub 100 has a fixture 260 for supplying water to the tub 100. The fixture is operational for supplying water when the water is turned on.

The right side 130 of the tub 100 further has a controller 270. The controller 260, shown attached to the right side 130 of the tub 100, may be on any of the sides 110, 120, 130, 140 or may be hand controlled.

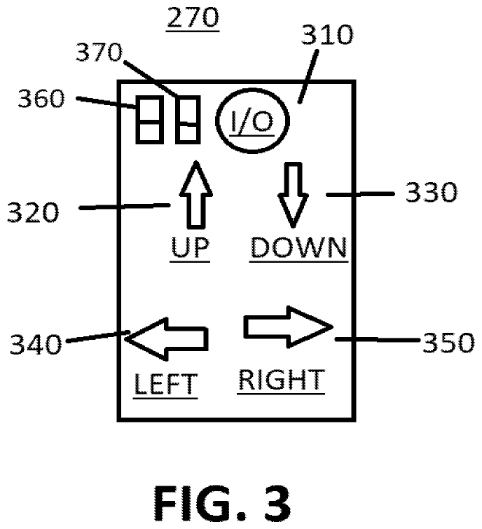

The controller 270 controls the movement of the seat 210 and is communicably coupled to the seat 210. The controller 270 may be hard-wired to the seat 210 via electrical or other wires or may be wirelessly connected to the seat 210. The controller 270 will be shown in greater detail in FIG. 3.

The tub 100 also has a motor 280. The motor 280 is used to power the controller 270 and the seat 210. The motor 280 may be communicably coupled to the seat 210 and the controller 270 using electrical wiring.

Referring to FIG. 3, an exemplary controller 270 is presented. The controller 270 is communicably coupled to the seat 210 and the motor 280. The controller 270 has actuators to effectuate a movement of the seat 210 or to turn on/off the water supply.

The controller 270 has an on/off button 310. The on/off button 310 is designated as I/O. The on/off button 310 may be a push button, a switch, a touch pad, etc. The on/off button 310 of the controller 270 controls the water supply to the tub 100.

The controller 270 also has control buttons for effectuate movement of the seat 210. The up button 320 is actuated to move the seat 210 in an upward direction, that being the seating area 230 being further from the floor. The up button 320 of the controller 270 may be a push button, a switch, a touch pad, etc.

The down button 330 is actuated to move the seat 210 in a downward direction, that being the seating area 230 being move closer to the floor of the tub 100. The down button 330 of the controller 270 may be a push button, a switch, a touch pad, etc.

To ease a user in getting into the tub 100, the controller 270 has a left button 340. When the left button 240 of the controller 260 is actuated, the seat 210 moves in a left direction, that being turning to be facing the right side 130 of the tub 100. The left button 340 of the controller 270 may be a push button, a switch, a touch pad, etc.

To ease the user in getting to a position to leave the tub 100, the controller 270 has a right button 350. When the right button 350 of the controller 270 is actuated, the seat 210 is moved in the right direction, that being turning the seat 210 to be facing the open side 140 of the tub 100 to exit the tub 100. The right button 350 of the controller 270 may be a push button, a switch, a touch pad, etc.

The controller 270 may also have a foot vibrator button 360 and a back massage button 370. When the foot vibrator button 360 is actuated, the foot rests 290 will vibrate such that the foot is massaged. Likewise, when the seat vibration button 370 is actuated, the back rest 220 is vibrated thus creating a massage like experience for the user. While, neither of the seat vibration button and foot vibration buttons are shown, the controller 270 may have other functions not described here.

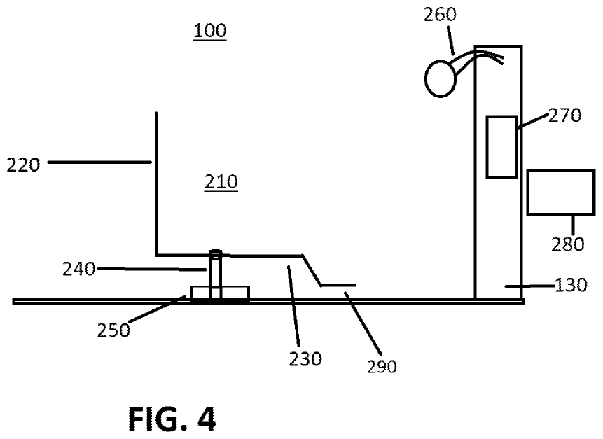

Now referring to FIG. 4, an exemplary view of the seat 210 being moved by actuating the controller 270 buttons 320, 330, 340, 350. The user desires to move the seat 210 down. The user presses the down button 330 on the controller 270. The controller 270 then communicates to the seat 210 to move in a downward direction. The seat 210 then moves downward and stops when the down button 330 is released.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A bather support system, the system comprising:
a walk-in tub;
a seat, the seat being integral to the walk-in tub;
a telescopic post, the telescopic post being communicably coupled to the seat;
a control and a motor, the control being communicably coupled to the motor;
the motor being communicable coupled to the seat;
one or more foot rests, the one or more foot rests being coupled to the seat, wherein the one or more foot rests being for providing a comfortable place to put a feet of the person; and
the control having at least one setting and the setting being changeable by a user and the control being communicably coupled to the seat, wherein when the user modifies at least one setting of the control the seat is adjusted in reflection of the modified control setting.

2. The bather support system of claim 1, wherein the controller further comprising an on/off switch.

3. The bather support system of claim 1, wherein the controller further comprising a up/down switch, wherein an altitude of the seat is determined by the setting of the up/down switch.

4. The bather support system of claim 1, wherein the controller further has a turning switch, the turning switch controlling the left movement and the right movement of the seat.

5. A method for supporting a person in a bath, comprising:
placing a seat in a walk-in bath tub;
coupling the seat to a motor and to a controller;
coupling a controller to the seat and to the motor, wherein the controller controls the movements of the seat;
adapting the position of the seat to a change in setting on the controller;
coupling one or more foot rests coupled to the seat, wherein the one or more foot rests to provide a comfortable place to put a feet of the person; and
collect the lees of the bales that have been removed by the brushes.

6. The method of claim 5 wherein the controller has a setting to power up and power down the motor.

7. The method of claim 5 wherein the controller has a setting when the setting is actuated to move the seat in an upward direction the controller controls the seat to move in the upward direction.

8. The method of claim 5 wherein the controller has a setting when the setting is actuated to move the seat in a downward direction the controller controls the seat to move in a downward direction.

9. The method of claim 5 wherein the controller has a setting when the setting is actuated to move the seat in a right turn direction the controller controls the seat to move in a right turn direction.

10. The method of claim 5 wherein the controller has a setting when the setting is actuated to move the seat in a left turn direction the controller controls the seat to move in a left turn direction.
